(19) United States
(12) Patent Application Publication
(10) Pub. No.: US 2008/0232697 A1
(43) Pub. Date: Sep. 25, 2008

(54) Image presentation system and operating method thereof

(75) Inventors: Jun-Cheng Chen, Taipei City (TW); Wei-Ta Chu, Taipei City (TW); Jin-Hau Kuo, Taipei City (TW); Chung-Yi Weng, Taipei City (TW); Ja-Ling Wu, Taipei City (TW)

Correspondence Address: Joe McKinney Muncy, PO Box 1364, Fairfax, VA, 22038-1364, US

(73) Assignee: National Taiwan University

(21) Appl. No.: 11/889,612

(22) Filed: Aug. 15, 2007

(30) Foreign Application Priority Data
Mar. 22, 2007 (TW) 96109868

(51) Int. Cl. G06K 9/62

(52) U.S. Cl. 382/225

(57) ABSTRACT

A system to display automatically organized images coordinating with pace of background music is disclosed. Users only need to give images and a music clip, and the system will automatically generate a presentation that combines visual and aural effects to display the organized images synchronously accompanying the music. Multiple images that have similar characteristics are well arranged and displayed at the same frame to emphasize the atmosphere of viewing experience. In addition, collaborative presentation of images that is synchronous to music even improves the enjoyment of image browsing.

### BACKGROUND OF THE INVENTION

1Field of the Invention

The invention relates to image presentation, and in particular to an image presentation system based on image organization and audiovisual composition.

2Description of the Related Art

With advances in technology of digital storage, digital photography has become increasingly popular. Nevertheless, large quantities of photos without appropriate. organization present problems in information access. Organization and access issues thus pose urgent requirements for advanced photo analysis and presentation techniques.

One of the most popular ways to display images is the image slideshow. In conventional image slideshow, images are displayed one-by-one according to alphabetical or temporal order. However, for large amounts of images, sequential browsing often takes much time and is tedious. Although some commercial tools for photo display provide some photo management, the browsing order or the browsing content must be defined manually.

Moreover, the manual definition usually requires users to be familiar with computer skills and photography.

### BRIEF SUMMARY OF INVENTION

A detailed description is given in the following embodiments with reference to the accompanying drawings.

An image presentation system is disclosed. The image presentation system comprises an image processing unit, a music analysis unit and an audiovisual composition unit. The image processing unit clusters image data into initial clusters, with at least two image data in one of the initial clusters. The music analysis unit analyzes energy difference in different frequency bands of audio data to segment the audio data into several sub-units. The audiovisual composition unit selects several presentation clusters from the initial clusters, with at least two image data in one of the presentation clusters. The audiovisual composition unit further obtains frames according to a predetermined arrangement method in which each frame consists of the image data in the same presentation cluster, and associates the frames with the sub-units to display the frames based on the sub-units.

An image presentation method is disclosed. First, several image data and an audio data are provided. The image data are clustered into several initial clusters, and at least two image data are in one of the initial clusters. Energy difference in different frequency bands of the audio data is analyzed to segment the audio data into several sub-units. Several presentation clusters are selected from the initial clusters, and at least two image data are in one of the presentation clusters. Several frames are obtained in which each frame consists of the image data in the same presentation cluster based on a predetermined arrangement method. The frames are associated with the sub-units to display the frames based on the sub-units.

A layout determination system for several image data is disclosed. The layout determination system comprises image storage, template storage and a template determination unit. The image storage stores the image data. The template storage stores several templates, and each template consists of several cells. The template determination unit selects one of the templates for a display layout according to the image data and a predetermined selection method, and generates the frame consisting of the image data according to the cells of the display layout, in which the number of the cells of the display layout is the same as the number of the image data.

A layout determination method for image data is disclosed. First, the image data is provided. Several templates are providing, and each template comprises several cells. One of the templates is selected as a display layout according to the image data and a predetermined selection method. The frame is generated according to the cells of the display layout, in which the number of cells of the layout is the same as the number of the image data.

### BRIEF DESCRIPTION OF DRAWINGS

The invention can be more fully understood by reading the subsequent detailed description and examples with references made to the accompanying drawings, wherein:

FIG. 1 is a diagram illustrating a processing procedure for image data and audio data in the image presentation system in an embodiment of the invention;

FIG. 2 is a diagram illustrating the audiovisual composition unit in FIG. 1;

FIG. 3 is a diagram illustrating the templates in an embodiment of the invention;

FIG. 4 is a diagram illustrating the synchronization of a frame and a sub-unit; and

FIG. 5 is a flowchart illustrating an image presentation method in an embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

A system to display automatically organized images coordinated with background music is disclosed. Users only need to provide images and a music clip, and the system automatically generates a presentation that combines visual and audio effects to display the organized images synchronously accompanying the music. In contrast to conventional systems, multiple images that have similar characteristics are well arranged and displayed at the same frame to emphasize the atmosphere of viewing experience. In addition, collaborative presentation of images that is synchronous to music further improves the enjoyment of image browsing.

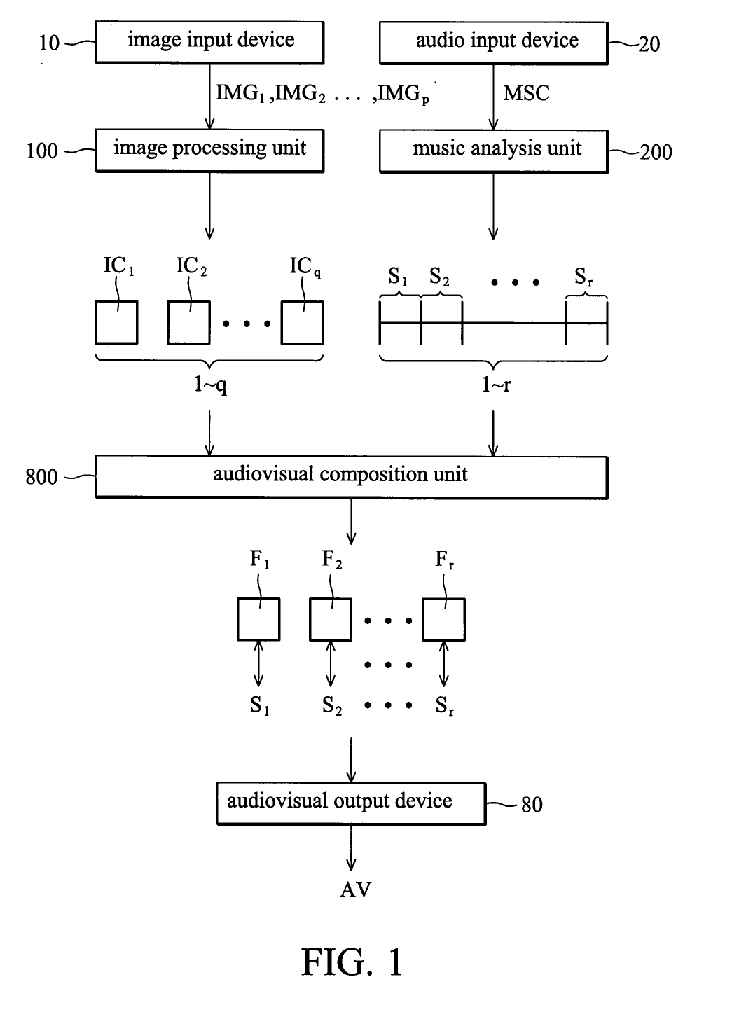

FIG. 1 is a diagram illustrating a processing procedure for image data and audio data in the image presentation system in an embodiment of the invention. The system comprises an image input device 10, an audio input device 20, an image processing unit 100, a music analysis unit 200, an audiovisual composition unit 800 and an audiovisual output device 80.

Image processing unit 100 accesses image data IMG₁,IMG₂, . . . ,IMGₚ from image input device 10. To display similar images in a same frame in the presentation, image processing unit 100 clusters image data IMG₁,IMG₂, . . . ,IMGₚ into several initial clusters IC₁,IC₂, . . . ,IC_{q} according to a predetermined clustering method, in which at least two image data are in an initial cluster ICₖ. For example, the image data having the same topic will be clustered into the same cluster, and be displayed in the same frame at the presentation.

Music analysis unit 200 accesses an audio data MSC, as a music clip, from audio input device 20. To coordinate images and music, the system attempts to switch each frame at the beat of the music, and the detection of the beat information may be achieved by analyzing the energy difference in different frequency bands of the music. Thus, music analysis unit 200 detects the beat information in audio data MSC by analyzing the energy difference in different frequency bands of the audio data MSC, and segments the audio data MSC into several sub-units S₁,S₂, . . . ,Sᵣ according to the detected beat information.

Audiovisual composition unit 800 composes or associates the clustered images and the music to display. However, a music clip is time-limited, such that a subset of image clusters has to be selected for display. Because the audio data MSC is segmented into r sub-units, to display each frame at each sub-unit, audiovisual composition unit 800 selects r presentation clusters PC₁,PC₂, . . . ,PCᵣ from the initial clusters IC₁,IC₂, . . . ,IC_{q} to display, in which at least two image data comprise one of the presentation clusters. Then, audiovisual composition unit 800 generates frames F₁,F₂, . . . ,Fᵣ according to a predetermined arrangement method in which frame F₁ consisting of PC₁, frame F₂ consisting of PC₂, etc.. Frames F₁,F₂, . . . ,Fᵣ corresponds to sub-units S₁,S₂, . . . ,Sᵣ respectively. As audio data MSC is played, frame Fᵢ is displayed at sub-unit Sᵢ. Further, audiovisual output device 80 outputs an audiovisual data AV by combining frames F₁,F₂, . . . ,Fᵣ and audio data MSC according to sub-units S₁,S₂, . . . ,Sᵣ for the synchronization of the image data and the audio data.

To display images which have the same topic in a same frame, image processing unit 100 clusters the image data based on the time information and the content of the image data to display the similar image data in a same frame. After accessing image data IMG₁,IMG₂, . . . ,IMGₚ, image processing unit 100 clusters IMG₁,IMG₂, . . . ,IMGₚ into several initial clusters IC₁,IC₂, . . . ,IC_{q} according to a predetermined clustering method. The criterion of the predetermined clustering method may be characteristics of the image data such as shooting time or content of the image data. For example, image processing unit 100 can cluster the image data based on the shooting frequency of the image data, in which the shooting frequency is computed by the time gap between two temporally adjacent image data and the image data that the shooting time are close are clustered into the same cluster. Moreover, to further discriminate the image data in the same cluster, the image data in the same cluster may be further clustered by the content of the image data such as dominant color and color layout of the image data. After the content-based clustering, the image data are clustered into several initial clusters IC₁,IC₂, . . . ,IC_{q}. Nevertheless, some image data are not appropriate to be displayed, such as blurred, underexposed, or overexposed images. Thus, image processing unit 100 may delete the improper image data from the input image data. However, according to different clustering methods, the timing to delete the improper image data is also different. For example, as the image data are clustered by time-based clustering in an embodiment, the improper image data are deleted after the time-based clustering to avoid affecting the result of the time-based clustering. After the improper image data are deleted, the image data may be subsequently clustered by content-based clustering. In another embodiment, the improper image data may be deleted after the content-based clustering.

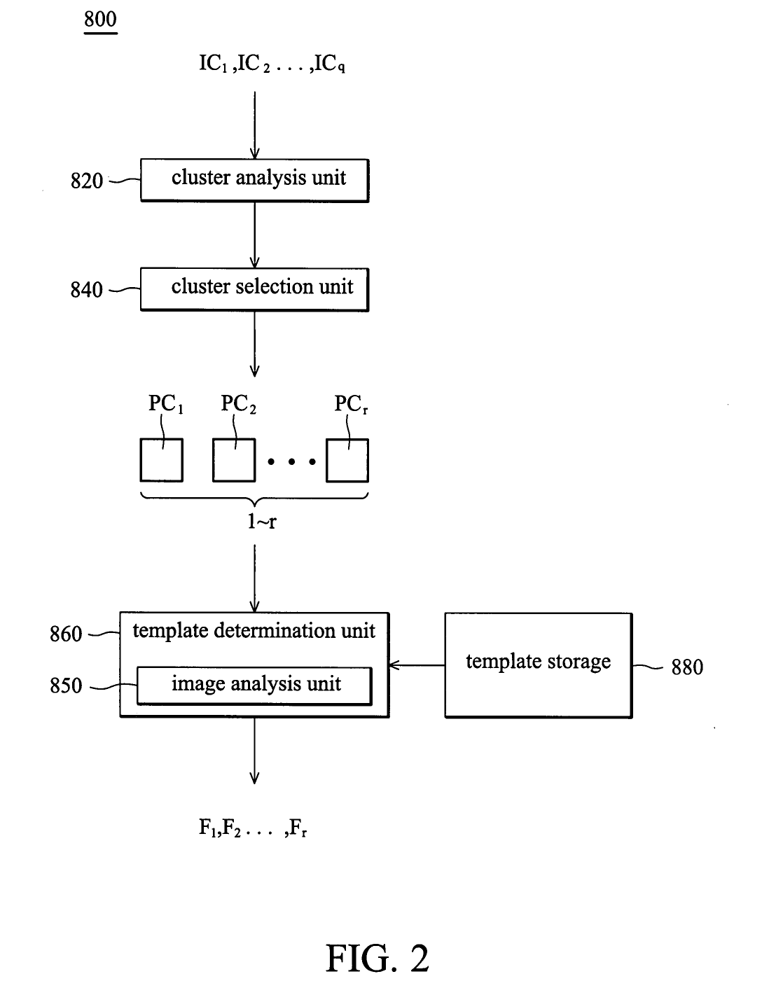

FIG. 2 is a diagram illustrating audiovisual composition unit 800 in FIG. 1. Audiovisual composition unit 800 comprises a cluster analysis unit 820, a cluster selection unit 840, a template determination unit 860 and a template storage 880. Template determination unit 860 further comprises an image analysis unit 850.

Due to the time-limited music clip, audiovisual composition unit 800 has to select a subset of the initial clusters which has some cluster characteristics to display. In an embodiment, the clusters which are more important are selected to be displayed. Cluster analysis unit 820 accesses the initial clusters IC₁,IC₂, . . . ,IC_{q}, to analyze the importance of the clusters according to the conformance and the shooting frequency of the image data in the same cluster. For example, as the conformance and the shooting frequency of a cluster are higher, i.e. the image data in the cluster are similar, the importance of the cluster is also more important. The shooting frequency of the image data in a cluster may be represented by the shooting time and the number of the image data in the cluster. For example, n image data are in a cluster and time t is the difference between the first image and the last image in the cluster, which is temporally sorted, then the shooting frequency of the cluster is denoted by n/t. The conformance of the image data in a cluster is computed according to dominant color and color layout of the image data. The distances between two images in terms of dominant color and color layout are calculated. The dominant color and color layout are defined in MPEG-7. The conformance of a cluster is defined as the average of normalized dominant color and color layout distances between two images in the cluster. If the average distance of a cluster is smaller, the conformance of the cluster is higher. Cluster analysis unit 820 computes the shooting frequency and the conformance of each initial cluster, and computes the importance of each initial cluster according to combining the shooting frequency and the conformance by a linear or a nonlinear function. Cluster selection unit 840 selects r clusters in which the importance is higher from the initial clusters to be the presentation clusters PC₁,PC₂, . . . ,PCᵣ, and each presentation cluster PCₖ corresponds to each sub-unit Sₖ.

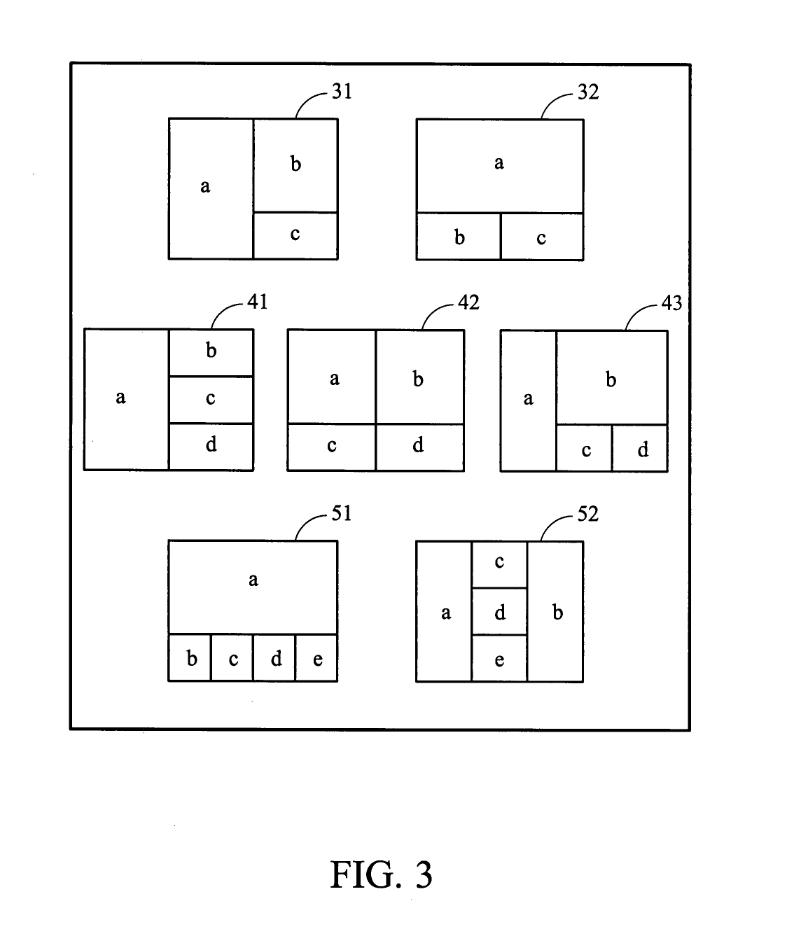

As well as selecting the presentation clusters form the initial clusters, audiovisual composition unit 800 further considers the layout for arranging the image data in the same cluster within a frame. The number of the image data in a cluster is different. To display the image data in the same cluster in a frame, several templates are defined for showing different numbers of image in a frame. The templates are stored in template storage 880. For example, a template in an embodiment is illustrated as FIG. 3. The templates stored in template storage 880 are 3-cell templates 31 and 32, 4-cell templates 41, 42 and 43, and 5-cell templates 51 and 52, with each cell displaying an image data.

Template determination unit 860 shown in FIG. 2 selects a corresponding display layout from the templates in template storage 880 for each presentation cluster. The number of cells of the display layout has to be the same as the number of image data in the corresponded presentation cluster. A frame consisting of the image data in the same presentation cluster is generated according to the determined display layout.

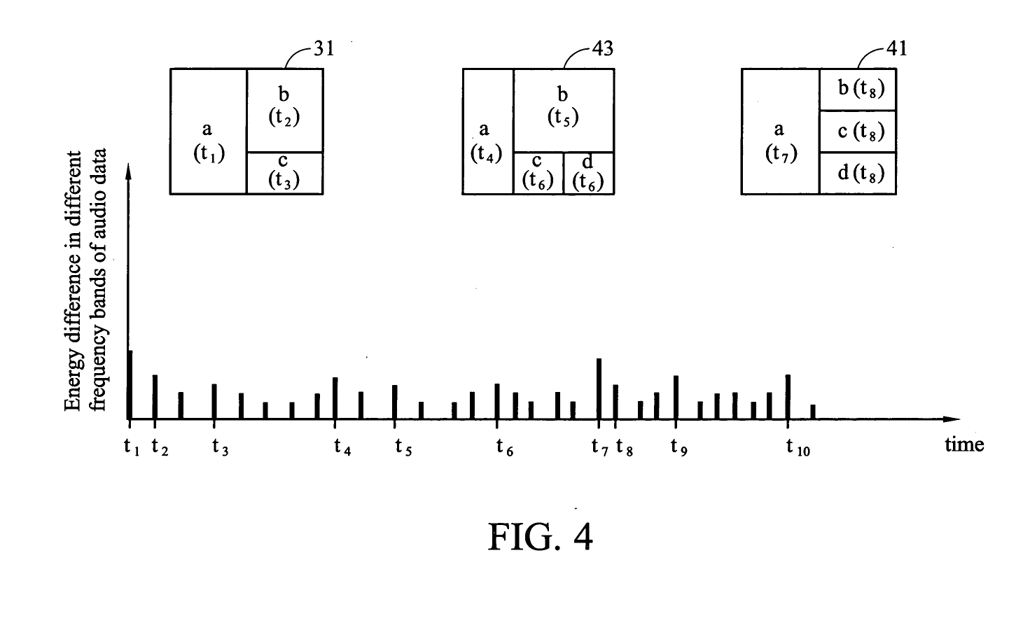

Because the area of each cell in the templates is different, the image data correspond to the cells according to some image characteristics of the image data. In an embodiment, the most important image data, for example, may correspond to the cell which has the largest area. Image analysis unit 850 computes the importance as the image characteristic value for an image data according to the face information and the color contrast of the image data. The importance of the image data with a face and significant color contrast is higher. In addition, template determination unit 860 creates a template vector for each template according to characteristics of the templates, such as area of the cells. Taking template 31 in FIG. 4 as an example, the area of cell a is ½ of the total area, the area of cell b is ⅓ of the total area and the area of cell c is ⅙ of the total area. Then, the template vector of template 31 TV₃₁ is (3, 2, 1). Template determination unit 860 also creates as a cluster vector for each presentation cluster based on the image importance. For example, three image data are in presentation cluster PCᵢ, and its cluster vector PVᵢ is represented by (I₁, I₂, I₃). Both the components of the template vector and the cluster vector are sorted in ascending order or in descending order.

Template determination unit 860 chooses the templates in which the number of the cells is the same as the number of the image data in the corresponding presentation cluster to be candidate templates. Then, the included angles between the cluster vector of the presentation cluster and the template vector of each candidate template are calculated. The candidate template corresponding to the smallest angle is selected to be the display layout of the presentation cluster. Because both the vectors are composed by sorted components, as a template is determined to be the display layout, the corresponding image data of each cell are determined at the same time.

For example, assume that the display layout of the presentation cluster PC₁ with three image data is to be determined, in which the importance of the three image data I₁, I₂ and I₃ are respectively 2, 2 and 1. The 3-cell templates, 31 and 32 (as shown in FIG. 3), are the candidate templates of presentation cluster PC₁. The cluster vector of presentation cluster PC₁ is PV₁=(2, 2, 1). The template vectors of templates 31 and 32 are TV₃₁=(3,2,1) and TV₃₂=(4,1,1) respectively. Accordingly, the included angle between PV₁ and TV₃₁ is the smallest one. Hence, the template 31 is selected to be the display layout of PC₁ and according to the sorted components, I₁ corresponds to 31a, I₂ corresponds to 31b and I₃ corresponds to 31c.

Once the matching between the image data and the cells are determined, the image data must be resized or cropped to fit in the limited region. Nevertheless, the ratio of width to height of each cell is often different from that of the selected image. The image data may be put into the corresponding cells by resizing either height or width of the image data to fit either height or width of the corresponding cells. However, this may result in the unfit resized image within the corresponding cells. Further, the image data may be put into the corresponding cells by resizing both height and width of the image data to fit that of the corresponding cells. This may result in distortion of the image. Further, the content of the image data may be distorted and some important information may be lost after resizing. Thus, image analysis unit 850 detects a region-of-interest (ROI) for each image data according to the image characteristics such as face information and color contrast. The ROI is the region with a face or significant color contrast in an image. For an image data, template determination unit 860 takes the ROI as a seed to obtain a clip region from the image data according to the aspect ratio of the cell corresponding to the image data, in which the clip region has the same aspect ratio as the designate cell and the information loss of the clip region is minimal. The clip region is resized to fit in with the corresponding cell. Finally, template determination unit 860 generates frame Fᵢ consisting of presentation cluster PCᵢ by the aforementioned method.

After obtaining frames F₁˜Fᵣ, audiovisual output device 80 displays the images in the frames accompanying sub-units S₁˜Sᵣ. Music analysis unit 200 analyzes energy difference in different frequency bands of audio data MSC to select some timestamps with large energy difference to be timing for switching the frames. FIG. 4 is a diagram illustrating the synchronization of a frame and a sub-unit. As shown in FIG. 4, music analysis unit 200 segments MSC into 3 sub-units: S₁: t₁˜t₄, S₂: t₄˜t₇ and S₃: t₇˜t₁₀. Frame F₁ will be displayed at S₁, frame F₂ will be displayed at S₂, and frame F₃ will be displayed at S₃. Timestamps t4 and t7 are timing for switching to the frames F₂ and F₃. One way to display images in a frame is to display that averagely. For example, timestamps t₁ and t₄ are at the 0^{th} second and the 6^{th} second of the audio data respectively, and frame F₁ consists of three cells a, b and c. To display the images in frame F₁, a-cell is displayed at the 0^{th} second, b-cell is displayed at the 2^{nd} second, and c-cell is displayed at the 4^{th} second. Frame F2 is switched at the 6^{th} second. In another embodiment, music analysis unit 200 selects the timestamps with larger energy difference to be timing for image display in a frame. As the aforenamed example, frame F₁ consists of presentation cluster PC₁ using template 31 as the display layout, and F₂ and F₃ are arranged according to template 43 and 41. Then, a-cell of F₁ is displayed at t₁, b-cell and c-cell of F₁ are displayed at t₂ and t₃ respectively, and frame F₂ is switched and a-cell of F₂ is displayed at t₄, b-cell of F₂ is displayed at t₅, c-ell and d-cell are displayed at t₆. Frame F₃ is switched and a-cell of F₃ is displayed at t₇ and b-cell, c-cell and d-cell of F₈ are displayed at t₈.

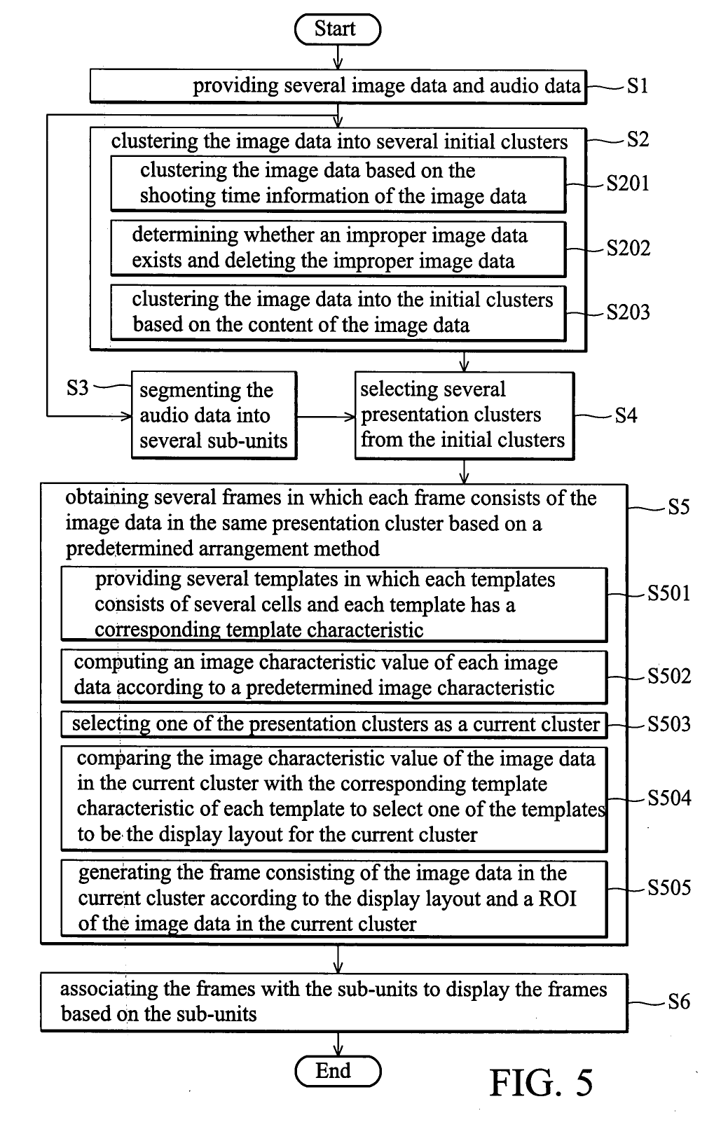

FIG. 5 is a flowchart illustrating an image presentation method of an embodiment of the invention. Several image data and an audio data are provided. (S1) The image data are clustered into several initial clusters, at least two image data are in one of the initial clusters. (S2) Energy difference in different frequency bands of the audio data is analyzed to segment the audio data into several sub-units. (S3) Several presentation clusters are selected from the initial clusters, at least two image data are in one of the presentation clusters. (S4) Several frames are obtained in which each frame consists of the image data in the same presentation cluster based on a predetermined arrangement method. (S5) The frames are associated with the sub-units to display the frames based on the sub-units. (S6)

In S2, the image data may be clustered into the initial clusters based on a predetermined clustering method. Whether an improper image exists in the initial clusters is determined and the improper image data is deleted, in which the improper image data is one of the image data according to a predetermined condition. Steps in an embodiment of S2 are as follows. The image data are clustered based on the shooting time information of the image data. (S201) Whether an improper image data, which is one of the image data according to a predetermined condition such as blurred, overexposed, or underexposed, exists is determined and the improper image data is deleted. (S202) The image data are further clustered into the initial clusters based on the content of the image data. (S203)

In S4, a cluster characteristic value for each initial cluster is computed according to a predetermined cluster characteristic such as the shooting frequency and the conformance of the image data. The presentation clusters are selected from the initial clusters according to the number of the sub-units and the cluster characteristic value of each initial cluster.

Steps of S5 in an embodiment of the invention are as follows. Several templates are provided, in which each templates consists of several cells and each template has a corresponding template characteristic. (S501) An image characteristic value of each image data is computed according to a predetermined image characteristic such as face information and color contrast. (S502) One of the presentation clusters is selected as a current cluster. (S503) The image characteristic value of the image data in the current cluster is compared with the corresponding template characteristic of each template to select one of the templates as the display layout for the current cluster. (S504) A ROI for each image data is defined based on the predetermined image characteristic. The frame consisting of the image data in the current cluster is generated according to the display layout and the ROI of the image data in the current cluster (S505), in which the number of cells of the display layout is the same as the number of the image data in the current cluster.

Moreover, in S504, the template characteristic is represented by a template vector comprising several components, and the number of the components is the same as the number of the cells of the template corresponding to the template vector. The components are computed based on the area of the cells of the template and each component corresponds to one of the cells. The image characteristic value of each image data in the current cluster is represented by a cluster vector. Candidate templates are selected from the templates in which the number of cells of the candidate templates is the same as the number of the image data in the current cluster. The included angles between the cluster vector and the template vector of each candidate template are calculated, and the candidate template corresponding to the smallest included angle is chosen to be the display layout.

In S505, a clip region for each cell of the display layout is obtained according to the aspect ratio of each cell and the ROI of the image data corresponding to each cell, and the clip region is resized and put into the corresponding cell to generate the frame.

In S6, timestamps for each sub-unit are selected according to the energy difference in different frequency bands of the audio data, in which the cells are displayed according to the timestamps. Finally, audiovisual data to display the frames accompanying the sub-units is generated.

The embodiment of the invention discloses a system for image presentation with automatic image classification and synchronizing to music beats. The disclosed image presentation method improves the enjoyment of image browsing. The disclosed image presentation system automatically analyzes images and displays frames tiled by multiple images accompanying music without manual elaboration of image classification and arrangement. Thus, the processing time is significantly reduced and the enjoyment of browsing experience is improved.

Systems and methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer system and the like, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image presentation system, comprising
an image processing unit clustering several image data into initial clusters, wherein at least two image data are in one of the initial clusters;
a music analysis unit to analyze energy difference in different frequency bands of audio data to segment the audio data into several sub-units; and
an audiovisual composition unit to select several presentation clusters from the initial clusters, wherein at least two image data are in one of the presentation clusters, to obtain frames according to a predetermined arrangement method in which each frame consists of the image data in the same presentation cluster, and to associate the frames with the sub-units to display the frames based on the sub-units.

2. The image presentation system as claimed in claim 1, further comprising an audiovisual output device to generate audiovisual data in which as the audiovisual data is displayed the frames are displayed in order according to the sub-units.

3. The image presentation system as claimed in claim 1, wherein the image processing unit further comprises clustering the image data into the initial clusters based on a predetermined clustering method.

4. The image presentation system as claimed in claim 3, wherein the image processing unit determines whether an improper image exists and deletes the improper image data, wherein the improper image data is one of the image data according to a predetermined condition.

5. The image presentation system as claimed in claim 3, wherein the image processing unit clusters the image data based on the time information of the image data.

6. The image presentation system as claimed in claim 3, wherein the image processing unit clusters the image data based on the content of the image data.

7. The image presentation system as claimed in claim 6, wherein the content of the image data comprises dominant color and color layout of the image data.

8. The image presentation system as claimed in claim 3, wherein the image processing unit clusters the image data based on a first predetermined clustering method and then clusters the image data based on a second predetermined clustering method after.

9. The image presentation system as claimed in claim 8, wherein the image processing unit determines whether improper image data exists and deletes the improper image data after clustering the image data based on the first predetermined clustering method, wherein the improper image data is one of the image data according to a predetermined condition.

10. The image presentation system as claimed in claim 8, wherein the image processing unit determines whether an improper image data exists and deletes the improper image data after clustering the image data based on the second predetermined clustering method, wherein the improper image data is one of the image data according to a predetermined condition.

11. The image presentation system as claimed in claim 8, wherein the first predetermined clustering method comprises clustering the image data based on the time information of the image data and the second predetermined clustering method comprises clustering the image data based on the content of the image data.

12. The image presentation system as claimed in claim 11, wherein the content of the image data comprises dominant color and color layout of the image data.

13. The image presentation system as claimed in claim 1, wherein the audiovisual composition unit comprises:
a cluster analysis unit to compute a cluster characteristic value for each initial cluster according to a predetermined cluster characteristic; and
a cluster selection unit to select the presentation clusters from the initial clusters according to the number of the sub-units and the cluster characteristic value of each initial cluster.

14. The image presentation system as claimed in claim 13, wherein the predetermined cluster characteristic comprises the shooting frequency of the image data in the same initial cluster.

15. The image presentation system as claimed in claim 13, wherein the predetermined cluster characteristic comprises the conformance of the image. data in the same initial clusters.

16. The image presentation system as claimed in claim 1 wherein the audiovisual composition unit comprises:
a template storage to store several templates, each comprising several cells; and
a template determination unit to choose one of the presentation clusters as a current cluster, to select one of the templates as a display layout for the current cluster according to the current cluster and a predetermined selection method, and to generate the frame consisting of the image data in the current cluster according to the cells of the display layout, wherein the number of the cells of the display layout is the same as the number of the image data in the current cluster.

17. The image presentation system as claimed in claim 16, wherein each template has a corresponding template characteristic, the template determination unit further comprises an image analysis unit to compute an image characteristic value for each image data according to a predetermined image characteristic, the predetermined selection method comprises comparing the image characteristic value of the image data in the current cluster with the corresponding template characteristic of each template to select one of the templates to be the display layout for the current cluster.

18. The image presentation system as claimed in claim 17, wherein the image analysis unit further defines an interest region for each image data based on the predetermined image characteristic, the template determination unit generates the frame consisting of the image data in the current cluster according to the display layout and the interest region of the image data in the current cluster.

19. The image presentation system as claimed in claim 18, wherein the template determination unit further obtains a clip region for each cell of the display layout according to a ratio of length to width of each cell and the interest region of the image data corresponding to each cell, adjusts the size of the clip region and puts the clip region into the corresponding cell to generate the frame.

20. The image presentation system as claimed in claim 17, wherein the image characteristic comprises face information of each image data.

21. The image presentation system as claimed in claim 17, wherein the image characteristic comprises color contrast of each image data.

22. The image presentation system as claimed in claim 17, wherein the template characteristic is represented by a template vector comprising several components and the number of the components is the same as the number of the cells of the template corresponding to the template vector.

23. The image presentation system as claimed in claim 22, wherein the components are computed based on the area of the cells of each template and each component corresponds to one of the cells.

24. The image presentation system as claimed in claim 22, wherein the predetermined selection method comprises:
obtaining a cluster vector by the image characteristic value of each image data in the current cluster;
selecting candidate templates from the templates in which the number of the cells of the candidate template is the same as the number of the image data in the current cluster;
calculating the angles between the cluster vector and the template vector of each candidate template; and
choosing the candidate template corresponding to the smallest angle to be the display layout.

25. The image presentation system as claimed in claim 1, wherein the music analysis unit further selects timestamps for each sub-unit according to the energy difference in different frequency bands of the audio data, wherein the cells are displayed according to the timestamps.

26. A image presentation method, comprising:
providing several image data and audio data;
clustering the image data into several initial clusters, wherein at least two image data are in one of the initial clusters;
analyzing energy difference in different frequency bands of the audio data to segment the audio data into several sub-units;
selecting several presentation clusters from the initial clusters, wherein at least two image data are in one of the presentation clusters;
obtaining several frames in which each frame consists of the image data in the same presentation cluster based on a predetermined arrangement method; and
associating the frames with the sub-units to display the frames based on the sub-units.

27. The image presentation method as claimed in claim 26, further comprising generating audiovisual data in which as the audiovisual data is displayed the frames are displayed in order according to the sub-units.

28. The image presentation method as claimed in claim 26, further comprising clustering the image data into the initial clusters based on a predetermined clustering method.

29. The image presentation method as claimed in claim 28, further comprising determining whether an improper image exists and deleting the improper image data, wherein the improper image data is one of the image data according to a predetermined condition.

30. The image presentation method as claimed in claim 28, wherein the predetermined clustering method comprises clustering the image data based on the time information of the image data.

31. The image presentation method as claimed in claim 28, wherein the predetermined clustering method comprises clustering the image data based on the content of the image data.

32. The image presentation method as claimed in claim 31, wherein the content of the image data comprises dominant color and color layout of the image data.

33. The image presentation method as claimed in claim 28, further comprising clustering the image data based on a first predetermined clustering method and then clustering the image data based on a second predetermined clustering method.

34. The image presentation method as claimed in claim 33, further comprising determining whether an improper image data exists and deleting the improper image data after clustering the image data based on the first predetermined clustering method, wherein the improper image data is one of the image data according to a predetermined condition.

35. The image presentation method as claimed in claim 33, wherein determining whether an improper image data exists and deleting the improper image data after clustering the image data based on the second predetermined clustering method, wherein the improper image data is one of the image data according to a predetermined condition.

36. The image presentation method as claimed in claim 33, wherein the first predetermined clustering method comprises clustering the image data based on the time information of the image data and the second predetermined clustering method comprises clustering the image data based on the content of the image data.

37. The image presentation method as claimed in claim 36, wherein the content of the image data comprises dominant color and color layout of the image data.

38. The image presentation method as claimed in claim 26, further comprising:
computing a cluster characteristic value for each initial cluster according to a predetermined cluster characteristic; and
selecting the presentation clusters from the initial clusters according to the number of the sub-units and the cluster characteristic value of each initial cluster.

39. The image presentation method as claimed in claim 38, wherein the predetermined cluster characteristic comprises the shooting frequency of the image data in the same initial clusters.

40. The image presentation method as claimed in claim 38, wherein the predetermined cluster characteristic comprises the conformance of the image data in the same initial clusters.

41. The image presentation method as claimed in claim 26, further comprising:
choosing one of the presentation clusters as a current cluster;
selecting one of the templates as a display layout for the current cluster according to the current cluster and a predetermined selection method; and
generating the frame consisting of the image data in the current cluster according to the cells of the display layout, wherein the number of the cells of the display layout is the same as the number of the image data in the current cluster.

42. The image presentation method as claimed in claim 41, wherein each template has a corresponding template characteristic, an image characteristic value for each image data is computed according to a predetermined image characteristic, the predetermined selection method comprises comparing the image characteristic value of the image data in the current cluster with the corresponding template characteristic of each template to select one of the templates as the display layout for the current cluster.

43. The image presentation method as claimed in claim 42, further comprising defining an interest region for each image data based on the predetermined image characteristic, generating the frame consisting of the image data in the current cluster according to the display layout and the interest region of the image data in the current cluster.

44. The image presentation method as claimed in claim 43, further comprising obtaining a clip region for each cell of the display layout according to a ratio of length to width of each cell and the interest region of the image data corresponding to each cell, adjusting the size of the clip region and putting the clip region into the corresponding cell to generate the frame.

45. The image presentation method as claimed in claim 42, wherein the image characteristic comprises face information of each image data.

46. The image presentation method as claimed in claim 42, wherein the image characteristic comprises color contrast of each image data.

47. The image presentation method as claimed in claim 42, wherein the template characteristic is represented by a template vector comprising several components and the number of the components is the same as the number of the cells of the template corresponding to the template vector.

48. The image presentation method as claimed in claim 47, wherein the components are computed based on the area of the cells of the template and each component corresponds to one of the cells.

49. The image presentation method as claimed in claim 47, wherein the predetermined selection method comprises:
obtaining a cluster vector by the image characteristic value of each image data in the current cluster;
selecting candidate templates from the templates in which the number of the cells of the candidate template is the same as the number of the image data in the current cluster;
calculating the angles between the cluster vector and the template vector of each candidate template; and
choosing the candidate template corresponding to the smallest angle to be the display layout.

50. The image presentation method as claimed in claim 26, further comprising selecting timestamps for each sub-unit according to the energy difference in different frequency bands of the audio data, wherein the cells are displayed according to the timestamps.

51. A layout determination system for several image data, comprising:
image storage for storing the image data;
a template storage for storing several templates, each comprising several cells; and
a template determination unit to select one of the templates as a display layout according to the image data and a predetermined selection method, and to generate the frame consisting of the image data according to the cells of the display layout, wherein the number of the cells of the display layout is the same as the number of the image data.

52. The layout determination system for several image data as claimed in claim 5 1, wherein each template has a corresponding template characteristic, the template determination unit comprises a image analysis unit to compute a image characteristic value for each image data according to a predetermined image characteristic, the predetermined selection method comprises comparing the image characteristic value of image data with the corresponding template characteristic of each template to select one of the templates to be the display layout.

53. The layout determination system for several image data as claimed in claim 52, wherein the image analysis unit further defines an interest region for each image data based on the predetermined image characteristic, the template determination unit generates the frame consisting of the image data according to the display layout and the interest region of the image data.

54. The layout determination system for several image data as claimed in claim 53, wherein the template determination unit further obtains a clip region for each cell of the display layout according to a ratio of length to width of each cell and the interest region of the image data corresponding to each cell, adjusts the size of the clip region and puts the clip region into the corresponding cell to generate the frame.

55. The layout determination system for several image data as claimed in claim 51, wherein the image characteristic comprises face information of each image data.

56. The layout determination system for several image data as claimed in claim 51, wherein the image characteristic comprises color contrast of each image data.

57. The layout determination system for several image data as claimed in claim 51, wherein the template characteristic is represented by a template vector comprising several components and the number of the components is the same as the number of the cells of the template corresponding to the template vector.

58. The layout determination system for several image data as claimed in claim 57, wherein the components are computed based on the area of the cells of each template and each component corresponds to one of the cells.

59. The layout determination system for several image data as claimed in claim 57, wherein the predetermined selection method comprises.:
obtaining a cluster vector by the image characteristic value of each image data;
obtaining candidate templates from the templates in which the number of the cells in the candidate template is the same as the number of the image data;
computing the angles between the cluster vector and the template characteristic of each candidate template; and
choosing the candidate template corresponding to the smallest angle to be the display layout.

60. A layout determination method for several image data, comprising:
providing the image data;
providing several templates, each template comprises several cells;
selecting one of the templates as a display layout according to the image data and a predetermined selection method; and
generating the frame according to the cells of the display layout, wherein the number of cells of the layout is the same as the numbers of the image data.

61. The layout determination method for several image data as claimed in claim 60, wherein each template has a corresponding template characteristic, an image characteristic value for each image data is computed according to a predetermined image characteristic, the predetermined selection method comprises comparing the image characteristic value of image data with the corresponding template characteristic of each template to select one of the templates to be the display layout.

62. The layout determination method for several image data as claimed in claim 61, further comprising defining an interest region for each image data based on the predetermined image characteristic, and generating the frame consisting of the image data according to the display layout and the interest region of the image data.

63. The layout determination method for several image data as claimed in claim 62, comprising obtaining a clip region for each cell of the display layout according to a ratio of length to width of each cell and the interest region of the image data corresponding to each cell, adjusting the size of the clip region and putting the clip region into the corresponding cell to generate the frame.

64. The layout determination method for several image data as claimed in claim 61, wherein the image characteristic comprises face information of each image data.

65. The layout determination method for several image data as claimed in claim 61, wherein the image characteristic comprises color contrast of each image data.

66. The layout determination method for several image data as claimed in claim 61, wherein the template characteristic is represented by a template vector comprising several components and the number of the components is the same as the number of the cells of the template corresponding to the template vector.

67. The layout determination method for several image data as claimed in claim 66, wherein the components are computed based on the area of the cells of the template and each component corresponds to one of the cells.

68. The layout determination method for several image data as claimed in claim 66, wherein the predetermined selection method comprises:
obtaining a cluster vector by the image characteristic value of each image data;
obtaining candidate templates from the templates in which the number of the cells of the candidate template is the same as the number of the image data;
computing the angles between the cluster vector and the template vector of each candidate template; and
choosing the candidate template corresponding to the smallest angle to be the display layout.
